(19) United States
(12) Patent Application Publication
(10) Pub. No.: US 2010/0237608 A1
(43) Pub. Date: Sep. 23, 2010

(54) UNIVERSAL MOUNTING FIXTURE AND INTERCHANGEABLE WATER PARK FEATURES AND METHODS

(75) Inventor: Randall Mosher, Loudonville, OH (US)

Correspondence Address: HAHN LOESER & PARKS, LLP, One GOJO Plaza, Suite 300, AKRON, OH, 44311-1076, US

(73) Assignee: RAIN DROP PRODUCTS, LLC, ASHLAND, OH (US)

(21) Appl. No.: 12/790,167

(22) Filed: May 28, 2010

Related U.S. Application Data
(63) Continuation of application No. 11/270,754, filed on Nov. 9, 2005.

(51) Int. Cl. F16L 5/00

(52) U.S. Cl. 285/136.1

(57) ABSTRACT

The present invention is directed to in one aspect a universal mounting fixture for installation of an associated water feature apparatus. The universal mounting fixture comprises a housing, which may be designed to be cast in position within a water park surface. The housing has an interior sealing surface, and an inlet adapted to be coupled to a water supply for providing water to a water feature mounted in association with the housing. The water feature has an inlet for engaging and sealing with the sealing surface. The sealing surface may define an opening dimensioned to accept the inlet of a water feature fixture in sealing relationship therewith. When water is supplied to the receptacle housing, it will in turn flow to the water feature mounted therewith. The receptacle housing and mounting surface accommodate both inlets from above grade and below grade water feature fixtures. The universal mounting fixture and associated water feature, which may be both above grade and below grade water features, allows the interchangeability of water features within a water park, providing flexibility in changing the design of the water park and features, without requiring reconfiguration of the water supply system or other aspects of the water park design. Other devices and methods according to the invention are set forth.

### CROSS REFERENCE TO RELATED APPLICATION

This application is a continuation of U.S. patent application Ser. No. 11/270,754 filed Nov. 9, 2005, which is hereby incorporated by reference.

### TECHNICAL FIELD

This invention relates generally to a universal mounting fixture and associated water features for a water park or the like, and methods for implementing the water features of a water park. More particularly, the invention relates to the design and use of mounting fixtures and associated water features, which facilitate installation and use of the water features, and enable alternative water features to be used and implemented in the operation of a water park, and to methods of operating a water park.

### BACKGROUND OF THE INVENTION

Water recreation has long been highly desirable to people, leading to the development of public pools and water parks, which offer fun and recreation to users. There has particularly been significant growth in the development of such facilities by communities or entities within communities. In implementing such facilities, it is desirable to provide the facility with attractions or a design which is appealing to people, which itself has led to the development of theme oriented water parks and attractions. At the same time, it may also be desirable to provide facilities which are easily operated, and which are safe for use by many different people. A water park or other facility having a pool creates the need for safety measures due to the risk of drowning. Many times, lifeguards or other safety measures must be provided, adding to the cost and complexity of operating such a facility. These risks are also present with wading pools that communities have provided, leading to closing or limited use of such facilities. Pools are also generally more expensive to install and maintain, leading many communities or the like to seek alternatives, while still providing a facility that will be appealing to and enjoyed by users.

Attempts to avoid these problems have led to the development of water spray parks, which include various water features and attractions, which spray, dump or otherwise dispense water. Such water features may be used in conjunction with a pool or without requiring a pool. The water features are typically of several types, including both above grade and below grade features. The above and below grade features include fixtures for receiving and dispensing water in a desired fashion. The water features in many cases are disposed around a surface area, and water is dispensed thereto from a main reservoir via pumping and conduit systems. Once installed, the water features are fixed in position relative to the surface area, thereby limiting the design and implementation of the water spray park or facility.

Further, the above grade and below grade water features developed so far, are also effectively fixed in position and operation once installed, again limiting the flexibility of the features. The above grade and below grade water features as developed do not enable interchangeability of the features, with above grade features having a mounting fixture being different than a mounting fixture associated with below grade features. It would be desirable to provide mounting system and methods which would enhance the adaptability of the water features to allow various configurations within the water park design to be implemented. It would also be desirable to provide water features themselves which can be adapted to provide different water spray or dispensing characteristics.

### SUMMARY OF THE INVENTION

Based upon the foregoing, the present invention overcomes the limitations of the prior developments relating to water park design and implementation. The invention in one aspect provides a universal mounting fixture for installation of water feature apparatus, comprising a receptacle housing designed to be cast in position within a water park surface. The receptacle housing has an interior mounting surface, and a channel therethrough with an inlet adapted to be coupled to a water supply for providing water to a water feature mounted in association with the receptacle housing. A seal member is disposed in association with the interior mounting surface, which defines an opening dimensioned to accept an inlet of a water feature fixture in sealing relationship therewith. When water is supplied to the receptacle housing, it will in turn flow to the water feature mounted therewith. The receptacle housing and mounting surface accommodate both inlets from above grade and below grade water feature fixtures. The universal mounting fixture thus enables both above grade and below grade water features to be installed in conjunction therewith, which enables flexibility in changing the design of the water park and features, without requiring reconfiguration of the water supply system or other aspects of the water park design.

The invention also relates to water features for use with a universal mounting fixture having a housing designed to be installed in a position within a water park surface. The mounting fixture housing has an inlet adapted to be coupled to a water supply for providing water to a water feature mounted in association with the housing. An interior sealing surface is adapted to engage and seal with a water feature. The water feature has an inlet which is selectively coupled to the mounting fixture in sealing engagement with the sealing surface thereof. Upon mounting of the water feature with the fixture, water from the water supply is directed to the water feature through the mounting fixture and inlet thereof.

The invention is also directed to a method of altering the configuration of water feature fixtures within a water park. The method comprises the steps of providing a plurality of universal mounting fixtures, with each mounting fixture having a receptacle housing with a water inlet, with the housing designed to be cast in position within a water park surface. The receptacle housing has an interior mounting surface with a seal, wherein both above grade and below grade water feature fixtures are accommodated by the mounting fixture. A supply of water is connected to the inlet of each mounting fixture. An above grade or below grade water feature is selectively installed in association with the particular mounting fixture in a sealing manner. The method further provides the ability to selectively change the water feature fixture in one or more of the mounting fixtures so as to alter the configuration of the water features in the water park.

The invention also provides a water feature design which allows the water dispensing characteristics of the water feature to be modified, again providing the ability to easily change the water features of a water park, and providing other benefits to facilitate maintenance of the water features.

These and other advantages and novel features of the present invention, as well as details of an illustrated embodiment thereof, will be more fully understood from the following description and drawings.

### BRIEF DESCRIPTION OF THE DRAWINGS

FIG. 1 is a perspective view of a type of water park in which the embodiments of the invention may be implemented.

FIG. 2 shows an exploded perspective view of a universal water feature mounting fixture for use in a water park such as shown in FIG. 1.

FIG. 3 is a side cross sectional view of the fixture a show in FIG. 2.

FIG. 4 is a cross sectional view of a below grade water feature according to an embodiment of the invention.

FIG. 5 is an exploded perspective view of the water feature as shown in FIG. 4.

### DETAILED DESCRIPTION OF THE INVENTION

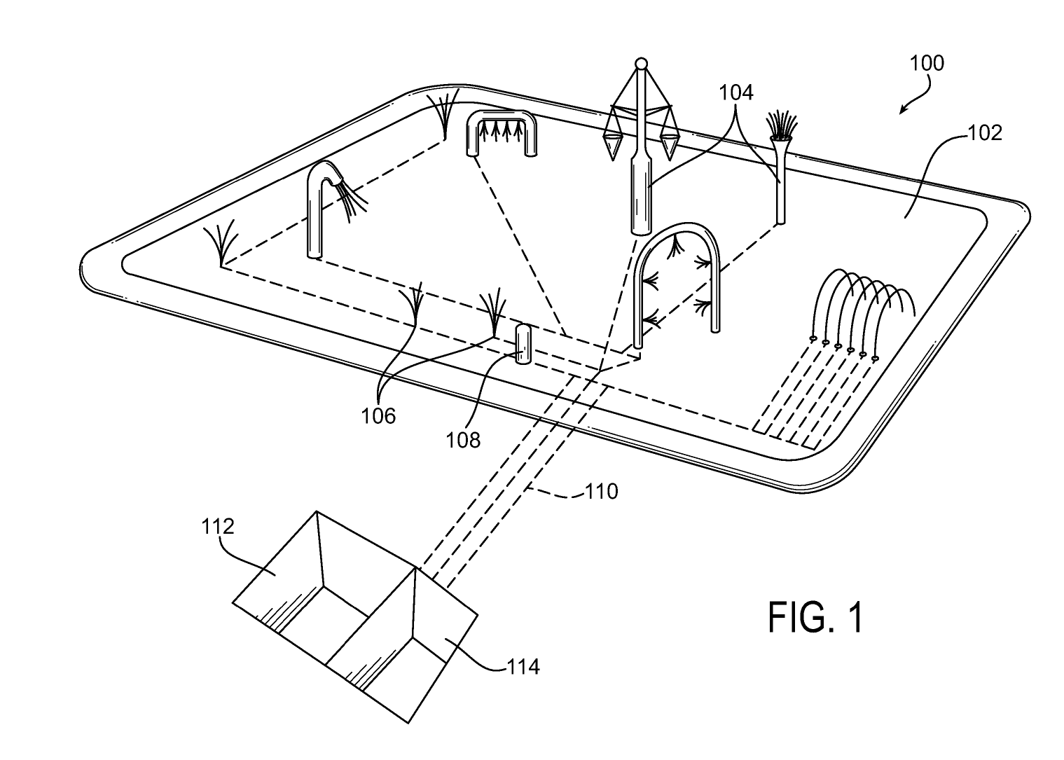

Turning now to the figures, FIG. 1 shows a schematic representation of a water park in which the present invention may be incorporated, being an example of the types of such parks that include water play features incorporated therein. Although the water park 100 is shown in FIG. 1 does not include a pool of any type, it should be recognized that the present invention may be used in various water park configurations, whether including a pool or not.

In this embodiment, water park 100 includes a surface area 102, on which a number of distinct water features are distributed. The water features include above grade features 104, which are merely representative of various types of above grade features that have or may be developed. The above grade features in general relate to features wherein water is distributed from an underground pipe to an above ground location via a play feature. Additionally, the water park 100 may also comprise below grade water features 106, which are adapted to be mounted below the surface 102 and produce sprays, showers or other water effects above the ground. The above grade or below grade features 104 and 106 may or may not be interactive, with interactive features allowing modification of the water effect produced by the feature. It should also be understood that the water features may be incorporated into other surfaces or locations in a water park, such as in association with walls or the like, instead of the ground surface.

In many such parks, one or more activation bollards 108 may be provided in conjunction with the water park 100, for selective actuation of the water features. A control system may automatically turn on and off the water features according to predetermined schedules or in a choreographed or patterned manner. Further, the control system may be used to render the system operational in the morning and throughout the day, and non-operational at night for example. The activation bollard may then allow initiation of a synchronized water flow sequence when it is triggered, with the system automatically shutting down the flow of water if no one is present at the water park. The activation bollard 108 may be simply controlled by movement passing in front of the bollard, wherein a signal is sent to the control system to turn on the system. If no activity is sensed, water is automatically shut off. The area of sensitivity of the bollard 108 may be adjustable, and can be used to control an indefinite number of play features. Other activation systems are also contemplated, such as a push button activator, step activator, wall mounted activator or the like. The control system may include operating software, to control the volumes of water supplied to the water features, as well as possibly the choreography of the water flow to the individual water features. Alternatively the system can be set to run continuously without activation, or to run certain features manually. Alternatively, control of operation may be performed automatically or manually by other suitable methods and systems.

Each of the water features 104 and 106 as described with reference to FIG. 1, are supplied with water via a piping or plumbing system 110. The plumbing system 110 extends from an equipment room 112 located adjacent to the water park 100 for example, and lead to the installation sites for the water features. The above grade or below grade water features are installed in a selected manner as to be hereinafter described in more detail. A reservoir 114 is provided for the water supply as an example, and additional or other water supplies may be provided as desired. As merely an example, each of the water features may be supplied with a volume of water as controlled by a flow control system, which directs the water-flow to each of the features through electrically operated solenoid controlled valves, from a single large manifold pipe within the equipment room 112. The manifold pipe may be connected to the water supply feature pump or pumps. The solenoid valves may be actuated by a processor associated with a computer control system. For ease of installation, an underground water distribution vault may contain the flow control manifold assembly and control system as well as pump assemblies as an example. Water used in the water park, may also be heated, filtered, sanitized or the like, and the park 100 will generally be configured for recirculation of water for conservation.

As an example, such water parks 100 as shown in FIG. 1 may be provided with a non-slip surface 102. The surface 102 may be gradually sloped, so as to direct water to a plurality of drains for returning water to the reservoir 114, where it may be filtered and chlorinated continuously to maintain water quality. The reservoir 114 may be a suitable tank holding a desired volume of water, for supply to the water features associated with a particular water park 100.

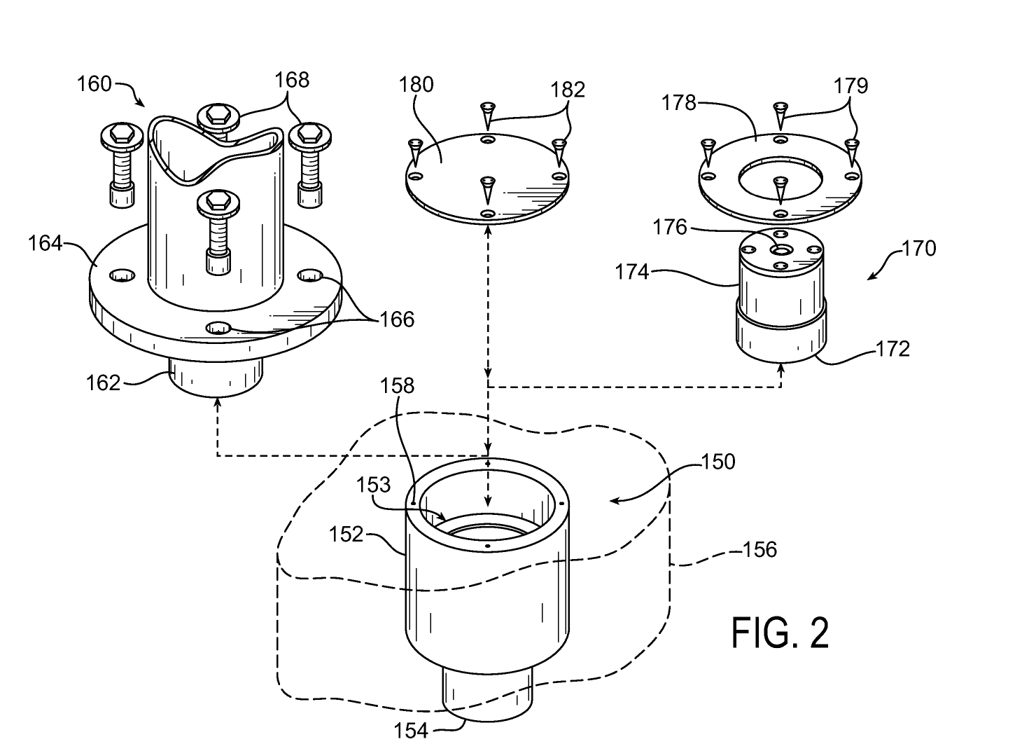

Turning now to FIG. 2, a universal water feature mounting fixture 150 is shown according to an embodiment of the invention. The universal mounting fixture 150 includes a universal water feature mounting housing 152, to which is operably coupled a water supply pipe 154, being part of the plumbing system 110 as described with reference to FIG. 1. At the terminating end of the water supply pipe 154, the housing 152 is coupled therewith, and thereafter cast into a concrete deck or other surface forming the surface 102 or other area of water park 100. Generally, housing 152 is mounted so as to be flush with the top surface 156 of the deck 102 forming the water park 100. The housing 152 may further include mounting holes 158 on a top surface thereof for mounting of water features thereto, as hereafter described.

It is a unique aspect of the present invention that the universal water feature mounting fixture 150 can accommodate both above grade and below grade water feature installation, thereby allowing a great amount of flexibility in both the design and implementation of a water park 100. For example, the ability to mount both below grade and above grade features in association with the same mounting fixture allows a park owner to selectively exchange or move water features to create a different layout or provide the park 100 with a completely new look for a new operational season. Further, a park owner may design in a number of possible water feature sites to which plumbing is directed. The installed mounting fixtures 150 may then be selectively covered until use thereof is desired, with the universal mounting fixture 150 installed for subsequent mounting of either below grade or above grade features at a later time. The flexibility provided by such a system greatly enhances the play experience obtainable at the park 100 and allows the use of newly developed water features and designs subsequent to initial installation of the park.

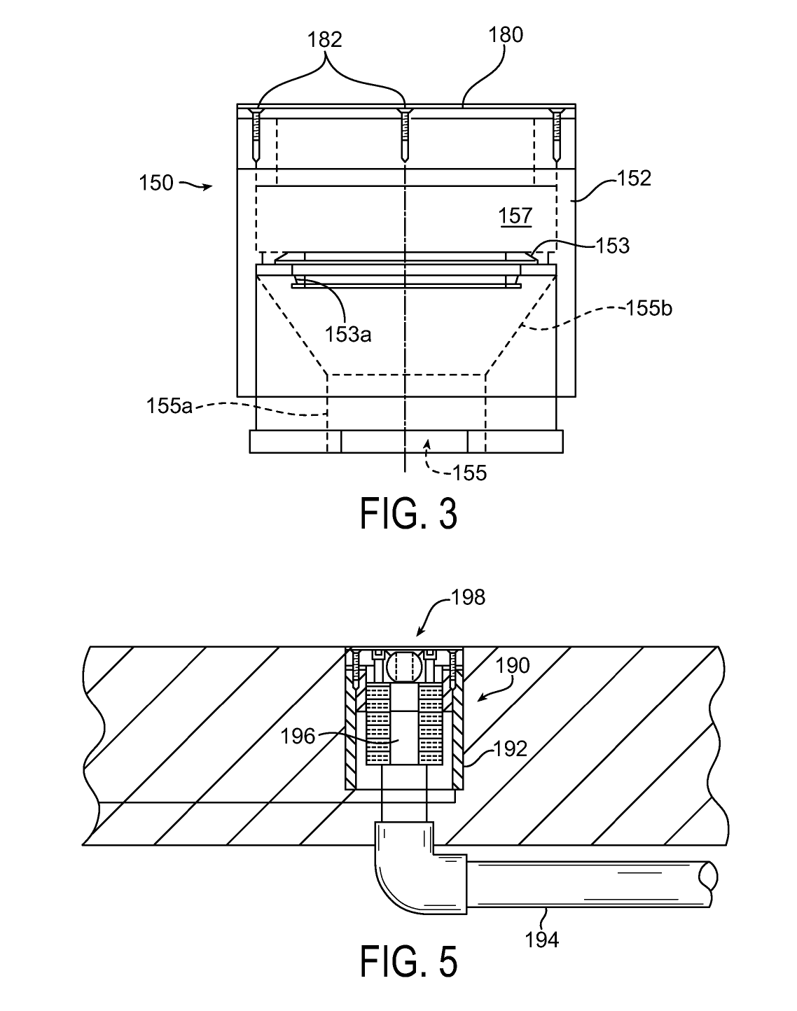

As shown in FIG. 3, an above grade water feature 160 includes an access pipe 162 operably coupled to the fixture 150 for supply of water to the feature 160. A mounting flange 164 may be provided with a plurality of mounting holes 166, and a plurality of fasteners 168 which may be used to engage the concrete deck adjacent to fixture 150, and position 160 inoperable position with fixture 150. For ease of installation, and as will be here and after described in more detail, the fixture 150 includes an internal seal 153 which mates with the access pipe 162 associated with feature 160. The internal seal 153 provides a fluid tight seal, even if access pipe 162 is mounted off-axis to some degree.

Alternatively, a below grade feature 170 may be installed in an operable connection with fixture 150, wherein water feature 170 comprises an access opening 172 associated with a housing 174. Water is directed to a ball jet 176 as an example, to provide dispensing of water from a location flush with the surface 156 in the water park. A retaining cover 178 secures the below grade water feature 170 in position. A plurality of fasteners 179 may engage the mounting holes 158 associated with the universal mounting fixture housing 152. Alternatively, during winterization of the water park or until use of the water feature mounting feature 150 is desired, a cover 180 may be provided to close the opening formed by the feature 150. A plurality of fasteners 182 may again be used to secure the winterization cover 180 there over.

Turning now to FIG. 3, the universal fixture 150 may be provided as a cast in-place receptacle formed by housing 152. The receptacle may be easily constructed of PVC or other suitable material, and contains internal seal structure 153. The fixture 150 is connected to a feature water supply pipe 154 as shown in FIG. 2. The water supply pipe is coupled to an inlet conduit 155 which has a connecting portion 155a, and a widened section 155b extending to an upper opening adjacent seal 153. The opening provided by seal 153 is dimensioned to accommodate predetermined sized water feature fixtures in sealing relationship, such as the above grade feature 160 or below grade feature 170 mentioned previously. The seal 153 may further include a sealing surface 153a which may be tapered to allow some flexibility in orienting the water feature fixture in sealing relationship therewith, even if the water feature coupling fixture or inlet is slightly off-center or tilted slightly. No further connections are necessary in order to properly couple the water feature with the supply of water introduced via the inlet opening 155 from a water supply pipe. The universal fixture 150 may be sized to accommodate different size water feature fixtures that may be available, and allows easy installation of any type of water play fixtures having a adaptive inlet sized to mate with the mounting fixture 150 as described. A winterization or storage cover 180 may be provided to selectively enclose the housing 152 until use of the universal fixture 150 is desired. It should be recognized that other suitable configurations for mounting water features in sealing relationship with the mounting fixture 150 are contemplated and encompassed within the invention.

As should be evident, the universal fixture 150 is able to accommodate either the above grade water feature 160 or below grade water feature 170 as previously described, with each universally mating to the fixture 150 so as to be coupled in sealing engagement with seal 153 when mounted therewith. As shown in FIG. 2, the above grade water feature 160 includes an adaptive inlet 162 which allows installation into sealing engagement with the internal seal 153, with sealing system 153 providing effective sealing with the inlet 162, even if slightly misaligned. Similarly, the below grade water play feature 170 may be provided with an adaptive inlet or housing 172 having a diameter to mate in sealing engagement with seal 153 associated with universal mounting fixture 150. It should be evident that different size inlets or adapters may allow proper sealing with water feature 170, even for different sized features 170 which may be available. The water feature 160 or 170 may also have interchangeable adaptive inlets to allow use with alternative sized mounting fixtures. Again, installation with the fixture 150 is simple and effective, even if water play feature 160 or 170 is slightly misaligned.

The construction of universal mounting fixture 150 provides many significant advantages, including allowing the customer to easily switch between above grade and below grade water play features at the site of any universal mounting fixture 150. This provides significant flexibility in park design and operation. The universal fixture 150 further eliminates all sealing problems which may be associated with the use of gaskets and the like in conventional water play feature installation. The universal fixture 150 allows an installer to position initial and subsequent water play features with the fixture 150, while easily enabling positioning of a water outlet to face in a desired direction or water play location within a water park, simply by rotating the water feature relative to mounting fixture 150. The sealing arrangement 153 further allows easy adjustment for leveling of above grade features, such as 160, without creating leaks based upon misalignment of the water play feature with a water supply pipe. The sealing system 153 further eliminates possible leaks that occur in association with movement or compression of a gasket associated with typical water feature installations. If desired, a supporting structure may also be used in conjunction with a water play feature for facilitating alignment or support thereof in association with universal mounting fixture 150. Such a support may be positioned within a space 157 above the sealing system 153 as an example. Further, if desired, insulation may be used around the water supply pipe or universal housing to avoid freezing of water around the pipe or the like.

The simplified installation, and elimination of leakages that can occur upon typical installation of a water play feature, if not precisely aligned and properly coupled to a water supply pipe, enables the installation to be performed by less skilled labors, and installation time is significantly reduced. The universal fixture 150 further allows a user to easily install and cap a water supply line for subsequent use in mounting an above grade or below grade water feature, again providing significant flexibility in both the design and subsequent modification of a water play park.

In this way, the invention provides a method of altering the configuration of water feature fixtures within a water park. The method comprises the steps of providing a plurality of universal mounting fixtures, with each mounting fixture having a receptacle housing having an inlet and designed to be positioned within a water park surface. The receptacle housing has an interior mounting surface with a sealing system, wherein both above grade and below grade water feature fixtures are accommodated by the plurality of mounting fixtures. A supply of water is provided from a water supply to the inlet of each mounting fixture, and thereby selectively to a water feature fixture selectively mounted in association with the receptacle housing. The user may selectively install an above grade or below grade water feature fixture in association with a particular universal mounting fixture in a sealing manner for use, and can selectively change the water feature fixture in one or more of the mounting fixtures so as to alter the configuration of the water features in the water park.

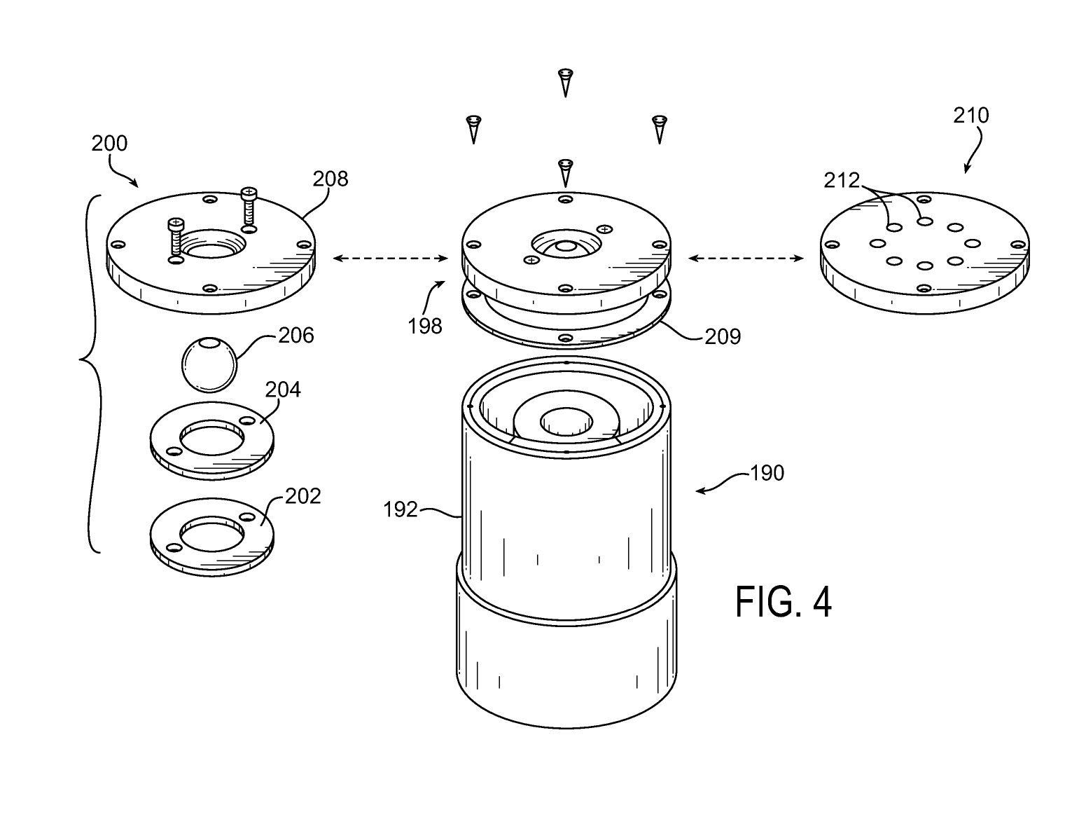

Turning now to FIGS. 4 and 5, a type of below grade water feature 190, having unique characteristics and capabilities for enhancing the water play feature and its operation is shown. The feature 190 comprises a housing 192 which may be installed using a universal fixture 150 as previously described, or otherwise installed in a cast in place position within a play surface, such as formed of concrete. A water supply pipe 194 is selectively coupled to the water feature 190, and supplies water to an internal channel 196. At an upper portion of feature 190, a water dispensing system generally designated 198 is provided, for creating various water dispensing characteristics from the feature 190.

The water dispensing system may be a ball nozzle assembly generally designated 200, as shown FIG. 4, or a patterned spray cover system 210 which are interchangeably and selectively used in association with the feature 190 to provide predetermined and varying water spray characteristics. In water play features known heretofore, the water dispensing characteristics of the feature are generally set by the manufacturer, and the user or installer is not able to modify these characteristics. In the present invention, the feature 190 allows varying water dispensing characteristics to be achieved by the user to customize these characteristics for the characteristics desired by the user, or to allow different characteristics to be achieved without changing the feature altogether. In this embodiment, as shown in FIG. 4, the ball nozzle assembly 200 may comprise a retaining ring 202 in association with a sealing gasket 204 which mounts and retains a swivel ball jet 206 in association with a cover 208. Screws or other fastening members may be used to secure the ball nozzle assembly 200 so as to retain the swivel ball jet 206 in a desired orientation which is selectively variable. As should be evident, the direction of the outlet of ball jet 206 may be oriented in any desired direction for dispensing of water therefrom in that desired direction. The swivel ball jet 206 in association with the cover 208, allows the swivel ball jet 206 to be variably positioned and then retained in the desired position by means of the retaining ring 202 in association with cover 208. The assembly 200 may then be attached to the top of the housing 192 along with a sealing gasket 209.

Alternatively, in place of the ball nozzle assembly 200, a patterned sprayed covered 210 may be fastened to housing 192 such that water will be dispensed throughout the plurality of the apertures 212, forming a patterned spray therefrom.

The ability to interchange different types of spray features in association with the feature 190 allows a great amount of flexibility to the user, and enhances operation of the below grade feature 190 to achieve various spray and dispensing characteristics therefrom. The ball nozzle assembly 200 allows a customer to easily adjust the water flow direction over a wide range, such as between 25 to 45 degrees from vertical in any direction for example, or to use different ball valves 206 for achieving different characteristics therefrom. For winterization, the ball nozzle 206 may be rotated 90 degrees, thereby effectively closing the system to the external environment, and eliminating the need for any winterization cover for example. The dispensing system 198 also allows for easy assess to the nozzle assembly for cleaning or maintenance. The ability to position the swivel ball jet 206 in any desired position also allows for a vertical water stream to be achieved, even if the enclosure 192 is installed out of plumb, and allows the customer to easily install and cap a water supply line for future use if desired. The ability to utilize differing water dispensing systems 198 with the same feature 190 also provides significant flexibility and provides differing water dispensing characteristics to be achieved without modification other than swapping out a water dispensing system 198 in association therewith.

The foregoing description of embodiments of the present invention has been provided for the purposes of illustration and description. It is not intended to be exhaustive or to limit the invention to the precise forms disclosed. Obviously, many modification and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A system for positioning and interchanging water features in a water park, comprising:
a plurality of mounting fixtures designed to be positioned within a water park surface, the plurality of mounting fixtures each having a water inlet for selective coupling to a water supply,
a plurality of water features, the plurality of water features having aesthetic play features and being capable of dispensing water therefrom to allow play interaction therewith,
each of the plurality of mounting fixtures capable of having a water feature selectively attached thereto in a manner to be coupled to the water inlet for providing water to the water feature selectively mounted in association with the mounting fixture, and
the plurality of mounting fixtures enabling selective interchanging of the water feature selectively attached therewith.

2. The system of claim 1, wherein the plurality of mounting fixtures are sealable with a water feature selectively attached thereto.

3. The system of claim 2, wherein the mounting fixtures include a sealing surface to seal with a water supply inlet of a water feature.

4. The system of claim 3, wherein the sealing surface accommodates an amount of misalignment of the water feature water supply inlet while properly sealing therewith.

5. The system of claim 1, wherein the plurality of mounting fixtures are configured to attach a water feature selected from the group consisting of above-ground water features, below-ground water features or both above-ground and below-ground water features.

6. The system of claim 1, wherein the plurality of mounting fixtures are configured to be cast into a concrete surface.

7. The system of claim 6, wherein the plurality of mounting fixtures allow water features to be rearranged with respect to the concrete surface.

8. The system of claim 1, wherein the plurality of water features include an adapted inlet to allow installation in association with a mounting fixture in a sealing relationship.

9. The system of claim 1, further comprising a cover to be selectively positioned to enclose the interior of the mounting fixture.

10. The system of claim 1, wherein the plurality of mounting fixtures allow water features to be selectively removed from a particular mounting fixture and another water feature attached to the particular mounting fixture.

11. The system of claim 1, wherein the plurality of mounting fixtures are formed to accommodate alternative sized inlets of the water features.

12. The system of claim 1, wherein at least one of the plurality of mounting fixtures includes a retaining cover formed to retain a below grade water feature.

13. The system of claim 1, wherein the plurality of water features include an adapted inlet to allow installation in association with any of the plurality of mounting fixtures in a sealing relationship.

14. The system of claim 1, wherein the plurality of mounting fixtures allow individual water features to be selectively positioned with any mounting fixture.

15. The system of claim 1, wherein the plurality of mounting fixtures allow a particular water feature to be selectively positioned with any of the plurality of mounting fixture.

16. The system of claim 1, wherein the plurality of mounting fixtures allow a water feature to be selectively positioned with any of the plurality of mounting fixture.

17. The system of claim 1, wherein the plurality of mounting fixtures are configured to attach an above-ground water feature both above-ground and below-ground water features.

18. The system of claim 1, wherein the plurality of mounting fixtures are configured to attach a below-ground water feature.
